(19) United States
(12) Patent Application Publication
(10) Pub. No.: US 2023/0185211 A1
(43) Pub. Date: Jun. 15, 2023

(54) TONER FOR DEVELOPMENT OF ELECTROSTATIC IMAGES

(71) Applicant: ZEON CORPORATION, Tokyo (JP)

(72) Inventors: Sakyo Yagyu, Tokyo (JP); Takeshi Hirata, Tokyo (JP)

(73) Assignee: ZEON CORPORATION, Tokyo (JP)

(21) Appl. No.: 18/003,253

(22) PCT Filed: Jun. 25, 2021
(86) PCT No.: PCT/JP2021/024197

§ 371 Date: Dec. 23, 2022

(30) Foreign Application Priority Data
Jun. 29, 2020 (JP) 2020-111902

(51) Int. Cl. G03G 9/097; C08F 236/10; G03G 9/087

(52) U.S. Cl. CPC G03G 9/09733; C08F 236/10; G03G 9/08728; C08F 2810/20; C08F 2800/20

(57) ABSTRACT

Provided is a toner for development of electrostatic images comprising colored resin particles containing a binder resin, a colorant, a charge control agent, and a release agent, wherein the colored resin particles have a storage modulus G′ (60) at 60° C. of 1.0×10⁸ to 5.0×10⁸ Pa, a storage modulus G′ (100) at 100° C. of 8.0×10⁴ to 2.3×10⁵ Pa, and a storage modulus G′ (150) at 150° C. of 1.4×10⁴ to 3.0×10⁴ Pa, these storage moduli being determined by dynamic viscoelastic analysis.

### TECHNICAL FIELD

The present invention relates to a toner for development of electrostatic image which is used for development of electrostatic latent images in electrophotography, electrostatic recording, electrostatic printing, and the like.

### BACKGROUND ART

A method of forming an electrostatic latent image on a photosensitive member and developing the electrostatic latent image with an electrostatic image development toner into a desired image has been widely used in image forming apparatuses such as electrophotographic apparatuses, electrostatic recording apparatuses, and electrostatic printing apparatuses, and such apparatuses are applied to copiers, printers, fax machines, multifunction machines thereof, and the like.

For example, in electrophotographic apparatuses using electrophotography, generally, after the surface of a photosensitive member comprising a photoconductive substance is uniformly charged by any of a variety of means, an electrostatic latent image is formed on the photosensitive member. The electrostatic latent image is then developed with (a) toner(s) (developing step), and the resulting toner image is transferred onto a recording material such as paper as needed (transferring step). The toner(s) is/are fixed onto the recording material with a fixing roll and a fixing film while heat and pressure are being applied (fixing step). Thus, a printed material is obtained.

Among the image forming steps, the fixing step usually requires heating of the fixing roll or the fixing film to a temperature of 150° C. or more during fixing, leading to a large amount of consumption of electricity as an energy source. To this, recent demands for energy saving and higher speed printing of the image farming apparatus have been increasing, and accompanied by this, there has been a demand for design of a toner which can maintain a high fixing rate even if the fixing temperature is reduced (toner having excellent low-temperature fixing properties).

To such demands, methods of reducing the glass transition temperature (Tg) of a toner, methods of adding a low melting point resin and/or a low molecular weight resin to a toner, methods of adding a low softening point substance (release agent) having releasing properties (detaching properties) such as a wax to a toner, and the like are proposed.

However, for a toner having enhanced low-temperature fixing properties, the setting temperature of the fixing roll or the fixing film during fixing can be reduced fusion (blocking (aggregation)) of toner particles readily occurs when the toner is used under a high temperature or is left (stored) for a long time, and may lead to a reduction in storage properties of the toner in some cases. For this reason, there has been a demand for development of toners which are designed in consideration of storage properties incompatible with low-temperature fixing properties such that the low-temperature fixing properties are improved without impairing the storage properties, and thus power consumption can be reduced.

For example, Patent Document 1 discloses a toner comprising toner particles comprising a binder resin and a colorant, wherein as viscoelastic characteristics of the toner measured at a frequency of 6.28 rad/sec using a rotary flat plate type rheometer, the storage modulus (G′60) at a temperature of 60° C. is 1.0×10⁷ to 1.0×10⁹ (Pa), the maximum value (G′p) of the storage modulus is present between 110° C. and 140° C., and G′p is 5.0×10⁴ to 5.0×10⁶ (Pa).

### RELATED ART DOCUMENTS

### Patent Document

Patent Document 1: JP 2012-177914 A

### SUMMARY OF THE INVENTION

### Problem to be Solved by the Invention

On the other hand, the technique disclosed in Patent Document 1 above is a technique using a polyester resin as a binder resin, and it does not ensure sufficient low-temperature fixing properties.

Moreover, a toner having improved low-temperature fixing properties may cause filming to the fixing film in the fixing step (a problem that after repetition of the fixing step of fixing a toner onto a recording material with the fixing roll and the fixing film while heat and pressure are being applied, a molten product of the toner adheres to the fixing film to coat the fixing film with the toner, reducing the releasing properties of the fixing film, which results in reduced off-set resistance) in some cases. For this reason, there has also been a demand for a toner having favorable low-temperature fixing properties and an appropriate solution to the filming problem.

An object of the present invention is to provide a toner for development of electrostatic images which has high storage stability, excellent low-temperature fixing properties, and high filming resistance to the fixing film.

### Means for Solving Problem

The present inventors, who have conducted extensive research to achieve the above object, have found that the above problems can be solved by using a toner for development of electrostatic images comprising colored resin particles containing a binder resin, a colorant, a charge control agent, and a release agent, the colored resin particles having a storage modulus G′ (60) at 60° C., a storage modulus G′ (100) at 100° C., and a storage modulus G′ (150) at 150° C. controlled within specific ranges, these storage moduli being determined by dynamic viscoelastic analysis, and thus have completed the present invention.

Specifically the present invention provides a toner for development of electrostatic images comprising colored resin particles containing a binder resin, a colorant, a charge control agent, and a release agent,

wherein the colored resin particles have a storage modulus G′ (60) at 60° C. of 1.0×10⁸ to 5.0×10⁸ Pa, a storage modulus G′ (100) at 100 ° C. of 8.0×10⁴ to 2.3×10^{s} Pa, and a storage modulus G′ (150) at 150° C. of 1.4×10⁴ to 3.0×10⁴ Pa, these storage moduli being determined by dynamic viscoelastic analysis.

In the toner for development of electrostatic images according to the present invention, preferably, the colored resin particles have a melt temperature (T1/2) of 150 to 220° C., the melt temperature being determined by a 1/2 method.

In the toner for development of electrostatic images according to the present invention, preferably, the colored resin particles further contain an additive having a polydiene structure and having a solubility in styrene at a temperature of 40° C. of 3 to 40 g/100 g.

In the toner for development of electrostatic images according to the present invention, preferably, the additive having a polydiene structure is a conjugated diene-aromatic vinyl thermoplastic elastomer.

In the toner for development of electrostatic images according to the present invention, preferably, the additive having a polydiene structure is a block copolymer containing at least one aromatic vinyl polymer block and at least one conjugated diene polymer block.

In the toner for development of electrostatic images according to the present invention, preferably, the release agent is a fatty acid ester compound having a number average molecular weight (Mn) of 500 to 1500.

In the toner for development of electrostatic images according to the present invention, preferably, the colored resin particles have a ratio G′ (100)/G′ (150) of 3.0 to 15.0, the ratio G′ (100)/G′ (150) being the ratio pf the storage modulus G′ (100) at 100° C. to the storage modulus G′ (150) at 150° C.

### Effects of Invention

The present invention can provide a toner for development of electrostatic images having high storage stability, excellent low-temperature fixing properties, and high filming resistance to fixing films.

### Description of Embodiments

The toner for development of electrostatic images according to the present invention (hereinafter, simply referral to as “toner” in some cases) is a toner for development of electrostatic images comprising colored resin particles containing a binder resin, a colorant, a charge control agent, and a release agent,

wherein the colored resin particles have a storage modulus G′ (60) at 60° C. of 1.0×10⁸ to 5.0×10⁸ Pa, a storage modulus G′ (100) at 100° C. of 8.0×10⁴ to 2.3×10⁵ Pa, and a storage modulus G′ (150) at 150° C. of 1.4×10⁴ to 3.0×10⁴ Pa, these storage moduli being determined by dynamic viscoelastic analysis.

First, a process of producing colored resin particles forming the toner according to the present invention will be described.

The process of producing colored resin particles forming the toner according to the present invention is mainly classified into dry processes such as a pulverization process and wet processes such as emulsion polymerization aggregation, dispersion polymerization, suspension polymerization, and dissolution suspension processes. Preferred are wet processes, which facilitate preparation of toners having high printing properties such as image reproductivity. Among these wet processes, preferred are polymerization processes such as emulsion polymerization aggregation, dispersion polymerization, and suspension polymerization because these facilitate preparation of toners having a particle size in micrometers and a relatively small particle size distribution. Among these, more preferred is suspension polymerization.

The emulsion polymerization aggregation process is a process of producing colored resin particles by polymerizing polymerizable monomer in an emulsion to prepare resin fine particles, and aggregating the resin fine particles with a colorant and the like. The dissolution suspension process is a process of producing colored resin particles by forming droplets through dropwise addition of a solution or dispersion of toner comments such as a binder resin and a colorant in an organic solvent to an aqueous medium, and then removing the organic solvent. In these processes, known techniques can be used.

The colored resin particles forming the toner according to the present invention can be produced by any of the wet processes and the dry processes. If (A) a suspension polymerization process as a preferred wet process or (B) a pulverization process as a representative dry process is used to produce the colored resin particles, the production is performed by the following process. First, (A) the suspension polymerization process will be described.

(A) Suspension Polymerization Process

### (A-1) Step of Preparing Polymerizable Monomer Composition

In the suspension polymerization process, first, a polymerizable monomer, a colorant, a charge control agent, a release agent, an additive having polydiene structure optionally used, and other additives optionally used are mixed and dissolved to prepare a polymerizable monomer composition. During the preparation of the polymerizable monomer composition, these materials are mixed using a medium type dispersing machine, for example.

In the present invention, the polymerizable indicates a polymerizable compound. The polymerizable monomer is converted into a binder resin as a result of polymerization of the polymerizable monomer. In the polymerizable monomer, preferred is use of a monovinyl monomer as the main component forming the polymerizable monomer. Examples of the monovinyl monomer include styrene-based monomers such as styrene, vinyltoluene, α-methylstyrene, and ethylstyrene; (meth)acrylate monomers such as methyl acrylate, ethyl acrylate, propyl acrylate, butyl acrylate, 2-ethylhexyl acrylate, dimethylaminoethyl acrylate, methyl methacrylate, ethyl methacrylate, propyl methacrylate, butyl methacrylate, 2-ethylhexyl methacrylate, and dimethylaminoethyl methacrylate; acrylic acid and methacrylic acid; nitrile compounds such as acrylonitrile and methacrylonitrile; amide compounds such as acrylamide and methacrylamide; olefins such as ethylene, propylene, and butylene; and the like. These monovinyl monomers can be used alone or in combination. Among these, preferred are styrene based monomers and (meth)acrylate monomers, and more preferred are styrene and butyl acrylate. Moreover, preferred is use of at least a styrene-based monomer and an (meth)acrylate monomer as monovinyl monomers because they can further enhance the low-temperature fixing properties of the resulting toner.

The proportion of styrene-based monomer units contained in the binder resin used in the present invention (proportion thereof in the total monovinyl monomer units) is preferably 73 to 76% by mass, more preferably 73 to 75% by mass, still more preferably 73.5 to 74-74.5% by mass. When the proportion of styrene-based monomer units is controlled within the range described above, high storage stability of the resulting toner and high filming resistance thereof to the fixing film can be obtained in a good balance. The proportion of (meth)acrylate monomer units (proportion thereof in the total monovinyl monomer units) is preferably 24 to 27% by mass, more preferably 25 to 27% by mass, still more preferably 25.5 to 26.5% by mass. When the proportion of (meth)acrylate monomer units is controlled within the range described above, the storage stability of the resulting toner can be increased while its low-temperature fixing properties can be further enhanced.

In the present invention, to further improve storage properties, preferred is use of any cross-linkable polymerizable monomer (cross-linking agent) together with the monovinyl monomer(s). The cross-linkable polymerizable monomer indicates a monomer having two or more polymerizable functional groups. Examples of the cross-linkable polymerizable monomer include aromatic divinyl compounds such as divinylbenzene, divinylnaphthalene, and derivatives thereof; ester compounds formed of two or more carboxylic acids esterified to an alcohol having two or more hydroxyl groups, such as ethylene glycol dimethacrylate and diethylene glycol dimethacrylate; other divinyl compounds such as N,N-divinylaniline and divinyl ether; compounds having three or more vinyl groups; and the like. These cross-linkable polymerizable monomers can be used alone or in combination. The cross-linkable polymerizable monomer is used in an amount of preferably 0.40 to 0.05 parts by mass, more preferably 0.42 to 0.80 parts by mass, still more preferably 0.45 to 0.80 parts by mass relative to 100 parts by mass of the monovinyl monomer(s). When the amount of the cross-linkable polymerizable monomer to be used and the content thereof are controlled within the ranges described above, the storage stability of the resulting toner, the low-temperature fixing properties thereof, and the filming resistance thereof to the fixing film can be further enhanced.

A macromonomer can be used as part of the polymerizable monomer. When any macromonomer is used, the storage properties and low-temperature fixing properties of the resulting toner can be further enhanced. The macromonomer refers to a reactive oligomer or polymer having a terminal polymerizable carbon-carbon unsaturated bond in the chain and having a number average molecular weight (Mn) of usually 1,000 to 30,000. Preferred macromonomers are those which provide a polymer having a higher glass transition temperature (Tg) than that of a polymer obtained without polymerizing the macromonomer. The macromonomer is used in an amount of preferably 0.03 to 5 parts by mass, more preferably 0.05 to 1 part by mass relative to 100 parts by mass of the monovinyl monomer(s).

Colorants are used in the present invention. If color toners (usually, four toners of black, cyan, yellow, and magenta toners are used) are produced, a black colorant, a cyan colorant, a yellow colorant, and a magenta colorant can be used for the respective color toners.

Examples of the black colorant to be used include pigments and dyes such as carbon black, titanium black, magnetic powders of zinc iron oxide, those of nickel iron oxide, and the like.

Examples of the cyan colorant to be used include compounds such as copper phthalocyanine pigments and derivatives thereof, and anthraquinone pigments and dyes. Specifically, examples thereof include C.I. Pigment Blues 2, 3, 6, 15, 15:1, 15:2, 15:3, 15:4, 16, 17:1, 60, and the like.

Examples of the yellow colorant to be used include compounds such as azo pigments such as monoazo pigments and disazo pigments, and fused polycyclic pigments and dyes. Specifically, examples thereof include C.I. Pigment Yellows 3, 12, 13, 14, 15, 17, 62, 65, 73, 74, 83, 93, 97, 120, 138, 151, 155, 180, 181, 185, 186, 214, and 219, C.I. Solvent Yellows 98 and 162, and the like.

Examples of the magenta colorant to be used include compounds such as azo pigments such as monoazo pigments and disazo pigments, and fused polycyclic pigments and dyes. Specifically, examples thereof include C.I. Pigment Reds 31, 48, 57:1, 58, 60, 63, 64, 68, 81, 83, 87, 88, 89, 90, 112, 114, 122, 123, 144, 146, 149, 150, 163, 170, 184, 185, 187, 202, 206, 207, 209, and 251, C.I. Solvent Violets 31, 47, and 59, C.I. Pigment Violet 19, and the like.

In the present invention, for the respective colors, these colorants may be used alone or in combination, and the amount of the colorant(s) to be used is preferably 1 to 10 parts by mass relative to 100 parts by mass of the binder resin (100 parts by mass of the polymerizable monomer to prepare the binder resin).

The charge control agent can be any charge control agent usually used for toners. Among these charge control agents, charge control resins having positive or negative chargeability are preferred because these have high compatibility with the polymerizable monomer and can impart stable charging properties (charging stability) to the toner particles to improve the dispersibility of the colorant. Furthermore, use of a charge control resin having positive chargeability is more preferred to prepare a positively chargeable toner.

Examples of charge control agents having positive chargeability include nigrosine dyes, quaternary ammonium salts, triaminotriphenylmethane compounds, and imidazole compounds; polyamine resins, quaternary ammonium group-containing copolymers, and copolymers containing a quaternary ammonium salt group as charge control resins preferably used; and the like.

Examples of charge control agents having negative chargeability include azo dyes containing a metal such as Cr, Co, Al, or Fe, salicylic acid metal compounds, and alkyl salicylic acid metal compounds; sulfonic acid group-containing copolymers, sulfonate group-containing copolymers, carboxylic acid group-containing copolymers, and copolymers containing a carboxylic acid salt group as the charge control resins preferably used; and the like.

The weight average molecular weight (Mw) of the charge control resin, which is a value against polystyrene standards determined by gel permeation chromatography (GPC) using tetrahydrofuran, is within the range of 5,000 to 30,000, preferably 8,000 to 25,000, more preferably 10,000 to 20,000.

The copolymerization proportion of the monomer having a functional group such as a quaternary ammonium group or a sulfonate group in the charge control resin is within the range of preferably 0.5 to 12% by mass, more preferably 1.0 to 6% by mass, still more preferably 1.5 to 3% by mass.

The content of the charge control agent is preferably 0.01 to 10 parts by mass, more preferably 0.03 to 8 parts by mass relative to 100 parts by mass of the binder resin (100 parts by mass of the polymerizable monomer to prepare the binder resin). By controlling the amount of the charge control agent to be added within this range, generation of fogging and print dirt can be effectively suppressed, and the dispersibility of the colorant can be appropriately enhanced.

The release agent can be any release agent usually used for toners. To obtain a toner having appropriately enhanced low-temperature fixing properties and hot offset resistance, preferred release agents are those having a number average molecular weight (Mn) of 500 to 1500, and preferred are fatty acid ester compounds having a number average molecular weight (Mn) of 500 to 1500. The term “fatty acid ester compound” indicates an esterified product of a monohydric alcohol and/or a polyhydric alcohol with a saturated fatty acid and/or an unsaturated fatty acid.

Specific examples of monohydric alcohols include monohydric saturated aliphatic alcohols such as methanol, ethanol, 1-propanol, 2-propanol, 1-butanol, 2-butanol, 1-pentanol, 1-hexanol, octanol, 2-ethyl-1-hexanol, nonyl alcohol, lauryl alcohol, cetyl alcohol, stearyl alcohol, and behenyl alcohol; monohydric unsaturated aliphatic alcohols such as allyl alcohol, methallyl alcohol, crotyl alcohol, and oleyl alcohol; monhydric alicyclic alcohols such as cyclohexanol; monohydric aromatic alcohols such as phenol, phenylmethanol (benzyl alcohol), methylphenol (cresol), p-ethylphenol, dimethylphenol (xylenol), nonylphenol, dodecylphenol, phenylphenol, and naphthol; and the like.

Specific examples of polyhydric alcohols include dihydric saturated aliphatic alcohols such as ethylene glycol and propylene glycol; dihydric aromatic alcohols such as catechol and hydroquinone; tri- or higher hydric saturated aliphatic alcohols such as glycerol, pentaerythritol, dipentaerythritol, and polyglycerol; and the like.

Among these monohydric alcohols and polyhydric alcohols, preferred are mono- to tetrahydric saturated aliphatic alcohols, more preferred are stearyl alcohol, behenyl alcohol, and pentaerythritol, still more preferred are stearyl alcohol and behenyl alcohol, and particularly preferred is behenyl alcohol.

Fatty acids used as raw materials for fatty acid ester compounds are saturated fatty acids and/or unsaturated fatty acids haying preferably 12 to 22 carbon atoms, more preferably 14 to 18 carbon atoms. Among these, particularly preferred are saturated fatty acids having the number of carton atoms in the above range because these facilitate preparation of a fatty acid ester compound haying a number average molecular weight (Mn) of 500 to 1500.

Specific examples of the saturated fatty acids having the number of carton atoms in the above range include, but should not be limited to, lauric acid (12 carton atoms), myristic acid (14 carton atoms), pentadecylic acid (15 carbon atoms), palmitic acid (16 carbon atoms), margaric acid (17 carbon atoms), stearic acid (18 carbon atoms), arachidic acid (20 carbon atoms), behenic acid (22 carton atoms), and the like. Among these saturated fatty acids, preferred are stearic acid (18 carbon atoms), arachidic acid (20 carbon atoms), and behenic acid (22 carbon atoms), and more preferred is stearic acid (18 carbon atoms).

Specific examples of the unsaturated fatty acids include, but should not be limited to, the following compounds:
palmitoleic acid (CH₃(CH₂)₅CH═CH(CH₂)₇COOH)
oleic acid (CH₃(CH₂)₇CH═CH(CH₂)₇COOH)
vaccenic acid (CH₃(CH₂)₅CH═CH (CH₂)₉COOH
linoleic acid (CH₃(CH₂)₃(CH₂CH═CH)₂(CH²)₇COOH)
(9, 12, 15)-linolenic acid (CH₃(CH₂CH═CH)₃(CH₂)₇COOH)
(6, 9, 12)-linolenic acid (CH₃(CH₂)₃(CH₂CH═CH)₃(CH₂)₄COOH)
eleostearic acid (CH₃(CH₂)₃(CH═CH)₃(CH₂)₇COOH)
arachadonic acid (CH₃(CH₂)₃(CH₂CH═CH)₄(CH₂)₃COOH)

These saturated fatty acids and/or unsaturated fatty acids may be used alone or in combination. Among these saturated fatty acids and unsaturated fatty acids, preferred are saturated fatty acids, more preferred are stearic acid, arachidic acid, and behenic acid, still more preferred are stearic acid and behenic acid, and particularly preferred is behenic acid.

The fatty acid ester compounds described above can be produced by a normal method. Examples of such a method of producing a fatty acid ester compound include a method of esterifying a monohydric alcohol and/or a polyhydric alcohol with a saturated fatty acid and/or an unsaturated fatty acid. Moreover, commercially available fatty acid ester compounds can also be used as the fatty acid ester compounds. Examples of commercially available fatty acid ester compounds include “WEP2”, “WEP3”, “WEP4”, “WEP5”, “WR6”, and “WE11” (all are trade names) available from NOF CORPORATION, and the like.

In the present invention, a release agent other than the fatty acid ester compound described above may be used as a release agent instead of or in addition to the fatty acid ester compound. Examples thereof include low molecular weight polyolefin waxes and modified waxes thereof; plant-derived natural waxes such as jojoba; petroleum waxes such as paraffin; mineral waxes such as ozokerite; synthetic waxes such as Fischer-Tropsch wax; polyhydric alcohol esters such as dipantaerythritol esters; and the like. These may be used alone or in combination.

The release agent has a number average molecular weight (Mn) of preferably 500 to 1500, more preferably 550 to 1200, still more preferably 550 to 1100. The number average molecular weight (Mn) of the release agent can be measured as a value against polystyrene standards by gel permeation chromatography (GPC) using tetrahydrofuran, for example.

The content of the release agent is preferably 1 to 30 parts by mass, more preferably 10 to 25 parts by mass, still more preferably 15 to 25 parts by mass relative to 100 parts by mass of the binder resin (100 parts by mass of the polymerizable monomer to prepare the binder resin). When the content of the release agent is controlled within the ranges above, the resulting toner can have a relatively uniform particle size distribution and further enhanced low-temperature fixing properties.

In the present invention, preferably, the colored resin particles further contain an additive having a polydiene structure and having a solubility in styrene at a temperature of 40° C. of 3 to 40 g/100 g or more. When such an additive having a polydiene structure is contained, the storage stability and low-temperature fixing properties of the resulting toner can be further enhanced.

The additive having a polydiene structure used in the present invention may be a compound having a polydiene structure (i.e., a structure derived from a diene compound) and having a solubility in styrene at a temperature of 40° C. of 3 to 40 g/100. and the additive is not particularly limited. The additive having a polydiene structure has a solubility in styrene at a temperature of 40° C. of preferably 5 to 30 g/100 g, more preferably 10 to 25 g/100 g.

Examples of the additive having a polydiene structure used in the present invention include, but should not be limited to, conjugated diene-aromatic vinyl thermoplastic elastomers which are polymers including structural units derived from a conjugated diene compound and structural units derived from an aromatic vinyl compound; conjugated diene elastomers such as polybutadiene rubber and polyisoprene rubber; and the like. Conjugated diene-aromatic vinyl thermoplastic elastomers are suitable. Among these conjugated diene-aromatic vinyl thermoplastic elastomers, particularly suitable are unhydrogenated conjugated diene-aromatic vinyl thermoplastic elastomers.

Examples of the conjugated diene-aromatic vinyl thermoplastic elastomer used in the present invention include random, block, and graft copolymers of a conjugated diene monomer, an aromatic vinyl monomer, and an optional different monomer copolymerizable therewith, hydrogenated products of these copolymers, and the like.

Such a conjugated diene-aromatic vinyl thermoplastic elastomer is not particularly limited. To further enhance the storage stability and low-temperature fixing properties of the toner, a block copolymer containing at least one aromatic vinyl polymer block and at least one conjugated diene polymer block can be suitably used.

Hereinafter, as a representative example of the conjugated diene-aromatic vinyl thermoplastic elastomer, a block copolymer containing at least one aromatic vinyl polymer block and at least one conjugated diene polymer block (hereinafter, simply referred to as “block copolymer” in some cases) will be described. The block copolymer used in the present invention contains at least one aromatic vinyl polymer block prepared by polymerization of an aromatic vinyl monomer and at least one conjugated diene polymer block prepared by polymerization of a conjugated diene monomer.

The aromatic vinyl monomer can be any aromatic vinyl compound, and examples thereof include styrene, α-methylstyrene, 2-methylstyrene, 3-methylstyrene, 4-methylstyrene, 2-ethylstyrene, 3-ethylstyrene, 4-ethylstyrene, 2,4-diisopropylstyrene, 2,4-dimethystyrene, 4-t-butylstyrene, 5-t-butyl-2-methylstyrene, 2-chlorostyrene, 3-chlorostyrene, 4-chlorostyrene, 4-bromostyrene, 2-methyl-4,6-dichlorostyrene, 2,4-dibromostyrene, vinyl naphthalene, and the like. Among these, preferred is use of styrene. For each of the aromatic vinyl polymer blocks, these aromatic vinyl monomers can be used alone or in combination. If the block copolymer has a plurality of aromatic vinyl polymer blocks, the aromatic vinyl polymer blocks may be formed of the same aromatic vinyl monomer units, or may be formed of different aromatic vinyl monomer units.

The aromatic vinyl polymer block may contain monomer units other than the aromatic vinyl monomer units as long as the aromatic vinyl monomer units are the main repeating units. Examples of such other monomers to be used in the aromatic vinyl polymer block include conjugated diene monomers such as 1,3-butadiene and isoprene (2-methyl-1,3-butadiene), α,β-unsaturated nitrile monomers, unsaturated carboxylic acid monomers or acid anhydride monomers, unsaturated carboxylic acid ester monomers, non-conjugated diene monomers, and the like. The content of monomer units other than the aromatic vinyl monomer units in the aromatic vinyl polymer block is preferably 20% by mass or less, more preferably 10% by mass or less, particularly preferably substantially 0% by mass.

The conjugated diene monomer can be any conjugated diene compound, and examples thereof include 1,3-butadiene, isoprene, 2,3-dimethyl-1,3-butadiene, 2-chloro-1,3-butadiene, 1,3-pentadiene, 1, 3-hexadiene, and the like. Among these, use of 1,3-butadiene and/or isoprene is preferred and use of isoprene is particularly preferred from the viewpoint of a high effect of improving storage stability, low-temperature fixing properties, and hot offset resistance. For each of the conjugated diene polymer blocks, these conjugated diene monomers can be used alone or in combination. If the block copolymer has a plurality of conjugated diene polymer blocks, the conjugated diene polymer blocks nay be formed of the same conjugated diene monomer units, or may be formed of different conjugated diene monomer units. Furthermore, unsaturated bonds of the conjugated diene polymer blocks may be partially hydrogenated.

The conjugated diene polymer block may contain monomer units other than the conjugated diene monomer units as long as the conjugated diene monomer units are the main repeating units. Examples of such other monomers to be used in the conjugated diene polymer blower include aromatic vinyl monomers such as styrene and α-methylstyrene, α,β-unsaturated nitrile monomers, unsaturated carboxylic acid monomers, unsaturated carboxylic acid anhydride monomers, unsaturated carboxylic acid ester monomers, non-conjugated diene monomers, and the like. The content of monomer units other than the conjugated diene monomer units in the conjugated diene polymer block is preferably 20% by mass or less, preferably 10% by mass or less, particularly preferably substantially 0% by mass.

Although not particularly limited, the vinyl bond content of the conjugated diene polymer block (the proportion of 1,2-vinyl bond units and 3,4-vinyl bond units in the total conjugated diene monomer units of the conjugated diene polymer block) is preferably 1 to 20 mol %, more preferably 2 to 15 mol %, particularly preferably 3 to 10 mol %.

The number of polymer blocks and the binding pattern of the blocks are not particularly limited as long as the block copolymer contains at least one aromatic vinyl polymer block and at least one conjugated diene polymer block. Specific examples of the block copolymer used in the present invention include the followings. In the specific examples below, Ar represents an aromatic vinyl polymer block, D represents a conjugated diene polymer back, X represents a residue of a coupling agent, and n represents an integer of 2 or more.
(a) An aromatic vinyl-conjugated diene block copolymer represented by Ar-D
(b) An aromatic vinyl-conjugated diene-aromatic vinyl block copolymer represented by Ar-D-Ar and/or (Ar -D)n-X
(c) A conjugated diene-aromatic vinyl-conjugated diene block copolymer represented by D-Ar-D and/or (D-Ar)n-X
(d) An aromatic vinyl-conjugated diene-aromatic vinyl-conjugated diene block copolymer represented by Ar-D-Ar-D
(e) A block copolymer composition comprising any combination of two or more of the block copolymers (a) to (d)

In the present invention, preferred is use of a block copolymer containing at least an aromatic vinyl-conjugated diene block copolymer represented by (a) Ar-D, and more preferred is use of a block copolymer containing at least an aromatic vinyl-conjugated diene block copolymer represented by (a) Ar-D and an aromatic vinyl-conjugated diene-aromatic vinyl block copolymer represented by (b) Ar-D-Ar and/or (Ar-D)n-X. In the conjugated diene-aromatic vinyl thermoplastic elastomer used in the present invention, the content of the aromatic vinyl-conjugated diene block copolymer represented by Ar-D is preferably 40% by weight or more, preferably 50% by weight or more, more preferably 55% by weight or more. Although not particularly limited, the upper limit is preferably 98% by weight or less, more preferably 95% by weight or less.

Although not particularly limited, the weight average molecular weight (Mw(Ar)) of the aromatic vinyl polymer block Ar in the aromatic vinyl-conjugated diene block copolymer represented by Ar-D is preferably 10000 to 50000, more preferably 15000 to 30000, and the weight average molecular weight (Mw(D)) of the conjugated diene polymer block D therein is preferably 50000 to 200000, more preferably 60000 to 150000.

In the aromatic vinyl-conjugated diene-aromatic vinyl block copolymer represented by Ar-D-Ar and/or (Ar-D)n-X, the weight average molecular weight (Mw(Ar)) of the aromatic vinyl polymer block Ar is not particularly limited, and is preferably 10000 to 30000, more preferably 15000 to 25000, and the weight average molecular weight (Mw(D)) of the conjugated diene polymer block D is not particularly limited, and is preferably 100000 to 300000, more preferably 120000 to 250000.

These weight average molecular weights above are values against polystyrene standards determined by gel permeation chromatography (GPC) using tetrahydrofuran.

In the block copolymer used in the present invention, the proportion of aromatic vinyl monomer units relative to the total monomer units is preferably 10 to 30% by mass, more preferably 12 to 25% by mass, still more preferably 15 to 25% by mass. When the proportion of aromatic vinyl monomer units is controlled within the ranges above, the compatibility of the block copolymer with the release agent and the compatibility of the block copolymer with the binder resin can be highly balanced, and the storage stability, low-temperature fixing properties, and hot offset resistance of the resulting toner can be further enhanced.

If all the polymer components forming the block copolymer are formed of only aromatic vinyl monomer units and conjugated diene monomer units, conjugated diene monomer units are decomposed by subjecting the block copolymer to ozone decomposition, and then reduction with lithium aluminum hydride by the method described in Rubber Chem. Technol., 45, 1205 (1972), and only aromatic vinyl monomer units can be extracted. Thus, the content of aromatic vinyl monomer units in the entire block copolymer can be readily measured.

Although not particularly limited, the weight average molecular weight (Mw) of the aromatic vinyl polymer block in the block copolymer is preferably 10000 to 50000, more preferably 20000 to 40000 as a value against polystyrene standards obtained by measurement by gel permeation chromatography (GPC) using tetrahydrofuran. Although not particularly limited, the weight average mole, molecular weight (Mw) of the conjugated diene polymer block in the block copolymer is preferably 50000 to 200000, more preferably 60000 to 180000.

Although not particularly limited, the melt index (MI) of the block copolymer specified by ASTM D-1238 (G condition, 200° C., 5 kg) is selected from the range of 1 to 1000 g/10 min, and is preferably 5 to 30 g/10 min.

The birch copolymer used in the present invention can be prepared by a normal method. Examples of the method of preparing the block copolymer include a method of successively polymerizing the aromatic vinyl monomer and the conjugated diene monomer by anionic living polymerization to form polymer blocks, and optionally coupling the polymer blocks with a coupling agent.

If the block copolymer used in the present invention is a block copolymer containing at least an aromatic vinyl-conjugated diene block copolymer represented by (a) Ar-D and an aromatic vinyl-conjugated diene-aromatic vinyl block copolymer represented by (b) Ar-D-Ar and/or (Ar-D)n-X, the following method can be used.

Examples thereof include the following method: first, by anionic living polymerization, the aromatic vinyl monomer is polymerized, and then the conjugated diene monomer is added and polymerized. Thereby, a terminally active diblock copolymer is prepared. In the next step, less than 1 molar equivalent of a coupling agent is added relative to the active terminal of the terminally active diblock copolymer to couple a portion of the terminally active diblock copolymer, thereby giving an aromatic vinyl-conjugated diene-aromatic vinyl block copolymer represented by (Ar-D)n-X. Thereafter; a polymerization terminator is added to inactivate the residual portion of the terminally active diblock copolymer, thereby giving a diblock copolymer represented by Ar-D. The aromatic vinyl-conjugated diene-aromatic vinyl block copolymer represented by Ar-D-Ar (where D contains a residue of the coupling agent) can be prepared by using a bifunctional coupling agent such as dichlorosilane, monomethyldichlorosilane, dimethyldichlorosilane, diphenyldimethoxysilane, diphenyldiethoxysilane, dichloroethane, dibromoethane, methylene chloride, or dibromomethane as the coupling agent in this method.

In the present invention, although the aromatic vinyl-conjugated diene block copolymer represented by (a) Ar-D and the aromatic vinyl-conjugated diene-aromatic vinyl block copolymer represented by (b) Ar-D-Ar and/or (Ar-D)n-X can be contained in any proportions, the aromatic vinyl-conjugated diene block copolymer represented by (a) Ar-D is contained in a proportion of preferably 10 to 90% by mass, more preferably 20 to 80% by mass. The arch vinyl-conjugated diene-aromatic vinyl block copolymer represented by (b) Ar-D-Ar and/or (Ar-D)n-X is contained in a proportion of preferably 10 to 90% by mass, mare preferably 20 to 80% by mass.

Alternatively, instead of the above-mentioned block copolymer, a random copolymer of an aromatic vinyl monomer and a conjugated diene monomer can also be used as the conjugated diene-aromatic vinyl thermoplastic elastomer. Such a random copolymer of an aromatic vinyl monomer and a conjugated diene monomer can be prepared by living anionic polymerization in the presence of an organic alkali metal compound as a polymerization initiator, for example. Examples of the organ alkali metal compound include organic lithium compounds, organic sodium compounds, organic potassium compounds, and the like. Specifically, examples thereof include organic monolithium compounds such as n-butyllithium, sec-butyllithium, t-butyllithium, hexyllithium, phenyllithium, and stilbenelithium; organic polyvalent lithium compounds such as dilithiomethane, 1,4-dilithiobutane, 1,4-dilithio-2-ethylcyclohexane, 1,3,5-trilithiobenzene, and 1,3,5-tris(lithiomethyl)benzene; organic sodium compounds such as sodium naphthalene; organic potassium con pounds such as potassium naphthalene; and the like. Among these organic netal cc mounds, n-butyllithinm is preferably used.

In the random copolymer of an aromatic vinyl monomer and a conjugated diene monomer used in the present invention, the proportion of aromatic vinyl monomer units is preferably 50% by mass or less, more preferably 45% by mass or, less, still more preferably 40% by mass or less in the total monomer units. When the proportion of aromatic vinyl monomer units is controlled within the ranges above, the compatibility of the random copolymer with the release agent and the compatibility of the block copolymer with the binder resin can be highly balanced, and the storage stability and low-temperature fixing properties of the resulting toner can be further enhanced.

Furthermore, in the present invention, a conjugated diene elastomer such as polybutadiene rubber or polyisoprene rubber can also be suitably used as the additive having a polydiene structure. The conjugated diene elastomer such as polybutadiene rubber or polyisoprene rubber can be prepared by living anionic polymerization in the presence of an organic alkali metal compound as a polymerization initiator. Eamples of usable organic alkali metal compounds include those listed above.

Although not particularly limited, the weight average molecular weight (Mw) of the additive having a polydiene structure used in the present invention is preferably 60,000 to 350,000, more preferably 80,000 to 250,000 as a value against polystyrene standards obtained in measurement by gel permeation chromatography (GPC) using tetrahydrofuran. When the weight average molecular weight (Mw) is controlled within the ranges above, the storage stabilily, low-temperature fixing properties, and hot offset resistance of the resulting toner can be further enhanced.

The content of the additive having a polydiene structure is preferably 1 to 10 parts by mass, more preferably 1 to 9 parts by mass, still more preferably 2 to 7 parts by mass, particularly preferably 2 to 5 parts by mass relative to 100 parts by mass of the binder resin (100 parts by mass of the polymerizable monomer to prepare the binder resin). By controlling the content of the additive having a polydiene structure within the ranges above, the effect of addition, namely, the effect of improving the storage stability and low-temperature fixing properties of the toner to be prepared can further increased.

In the present invention, an acrylic resin can be used as another additive to further suppress bleed out of the release agent.

The acrylic resin is a copolymer (acrylate copolymer) mainly containing at least one of an acrylate ester and a methacrylate ester and at least one of acrylic acid and methacrylic acid. A preferred acid monomer is acrylic acid.

Examples of the acrylic resin include copolymers of an acrylate ester and acrylic acid, those of an acrylate ester and methacrylic acid, those of a methacrylate ester and acrylic acid, those of a methacrylate ester and methacrylic acid, those of an acrylate ester, a methacrylate ester, and acrylic acid, those of an acrylate ester, a methacrylate ester, and methacrylic acid, and those of an acrylate ester, a methacrylate ester, acrylic acid, and methacrylic acid. Among these, preferred is use of a copolymer of an acrylate ester, a methacrylate ester, and acrylic acid.

The acrylic resin has an acid value of usually 0.5 to 7 mgKOH/g, preferably 1 to 6 mgKOH/g, more preferably 1.5 to 4 mgKOH/g. Control of the acid value of the acrylic resin within this range enables favorable preparation of desired colored resin particles while ensuring favorable heat-resistant storage properties, favorable low-temperature fixing properties, and favorable print durability under low temperature/low humidity environments and high temperature/high humidity environments.

The acid value of the acrylic resin is a value measured according to JIS K 0070, which is a standard oil and fat analysis method specified by JAPAN Industrial Standards Committee (JICS).

The acrylic resin has a weight average molecular weight (Mw) of usually 6,000 to 50,000, preferably 8,000 to 25,000, more preferably 10,000 to 20,000.

Control of the weight average molecular weight (Mw) of the acrylic resin within this range can ensure favorable heat-resistant storage properties, favorable durability, and favorable low-temperature fixing properties.

The acrylic resin has a glass transition ta_{T}erature Tg of usually 60 to 85° C., preferably 65 to 80° C., more preferably 70 to 77° C. Control of the glass transition temperature within this range can ensure favorable heat-resistant storage properties and favorable low-temperature fixing properties.

The glass transition temperature Tg of the acrylic resin can be determined according to ASTM D3418-82, for exmple.

The ratio of acrylate ester monomer units, methacrylate ester monomer units, acrylic acid monomer units, and methacrylic acid monmer units in the acrylic resin is not particularly limited as long as the acrylic resin satisfies the acid value, weight average molecular weight Mw, and glass transition temperature requirements specified above.

The ratio of these four monomer units above can be adjusted by selecting the mass ratio of the amounts of the acrylate ester, the methacrylate ester, acrylic acid, and methacrylic acid to be added for synthesis of the copolymer. The mass ratio of the amounts thereof to be added maybe (acrylate ester and/or methacrylate ester):(acrylic acid and/or methacrylic acid)=(99 to 99.95):(0.05 to 1), for example, and is preferably (acrylate ester and/or methacrylate ester):(acrlic acid and/or methacrylic acid)=(99.4 to 99.9):(0.1 to 0.6), more preferably (acrylate ester and/or methacrylate ester):(acrylic acid and/or methacrylic acid)=(99.5 to 99.7):(0.3 to 0.5). Among these polymerizable monomers, the acrylate ester and or the methacrylate ester may be replaced by a different monomer, such as any of the styrene derivatives, the nitrile compounds, and the amide compounds listed for the monovinyl monomer forming the binder resin above, in the range not impairing the effects of the present invention. The proportion thereof is 10% by mass or less, preferably 2% by mass or less of the total amount of the acrylate ester and/or the methacrylate ester to be added. Preferably, the acrylate ester and/or the methacrylate ester is not replaced.

Examples of the acrylate ester used in the acrylic resin include methyl acrylate, ethyl acrylate, n-propyl acrylate, isopropyl acrylate, n-butyl acrylate, isobutyl acrylate, sec-butyl acrylate, tert-butyl acrylate, n-pentyl acrylate, sec-pentyl acrylate, isopentyl acrylate, neopentyl acrylate, n-hexyl acrylate, isohexyl acrylate, neohexyl acrylate, sec-hexyl acrylate, tert-hexyl acrylate, and the like. Among these, preferred are ethyl acrylate, n-propyl acrylate, isopropyl acrylate, and n-butyl acrylate, and more preferred is n-butyl acrylate.

Examples of the methacrylic acid ester used in the acrylic resin include methyl methacrylate, ethyl methacrylate, n-propyl methacrylate, isopropyl methacrylate, n-butyl methacrylate, isobutyl methacrylate, sec-butyl methacrylate, tert-butyl methacrylate, n-pentyl methacrylate, sec-pentyl methacrylate, isopentyl methacrylate, neopentyl methacrylate, n-hexyl metnacrylate, isohexyl methacrylate, neohexyl methacrylate, sec-hexyl methacrylate, tert-hexyl methacrylate, and the like. Among these, preferred are methyl methacrylate, n-propyl methacrylate, isopropyl methacrylate, and n-butyl methacrylate, and more preferred is methyl methacrylate.

The amount of the acrylic resin to be added is preferably 0.3 to 4 parts by mass, more preferably 0.5 to 3.0 parts by mass, still more preferably 0.7 to 2.0 parts by msss relative to 100 parts by mass of the binder resin (100 parts by mass of the polymerizable monomer to prepare the binder resin). Control of the amount of the acrylic resin to be added within this range can ensure favorable environmental stability and a sufficient effect of addition.

Although the acrylic resin to be used can be a commercially available product, the acrylic resin can be prepared by a known process such as solution polymerization, aqueous solution polymerization, ion polymerization, high temperature and pressure polymerization, or suspension polymerization.

Furthermore, a molecular weight modifier may be used as another additive. The molecular weight modifier to be used can be any molecular weight modifier usually used for toners. Examples thereof include mercaptans such as, t-dodecylmercaptan, n-dodecylmercaptan, n-octylmercaptan, and 2,2,4,6,6-pentamethylheptane-4-thiol; thiuram disulfides such as tetramethylthiuram disulfide, tetraethylthiuram disulfide, tetrabutylthiuram disulfide, N,N′-dimethyl-N,N′-diphenylthiuram disulfide, N,N′-dioctadecyl-N,N′-diisopropylthiuram disulfide; and the like. These molecular weight modifiers may be used alone or in combination. The molecular weight modifier is used in an amount of preferably 5 parts by mass or less, more preferably 0.5 to 4 parts by mass, still more preferably 0.5 to 3 parts by mass relative to 100 parts by mass of the binder resin (100 parts by mass of the polymerizable monomer to prepare the binder resin).

(A-2) Suspension Step for Preparing Suspension (Droplet Forming Step)

In the next step, the polymerizable monomer composition, which is prepared in the step (A-1) of preparing the polymerizable monomer composition and comprises the polymerizable monomer, the colorant, the charge control agent, and the release agent, and optionally the additive having a polydiene structure, is dispersed in an aqueous dispersive medium, and a polymerization initiator is added. Thereafter, droplets of the polymerizable monomer composition are formed. Here, suspension means formation of droplets of the polymerizable monomer composition in the aqueous dispersive medium. The dispersion treatment for forming droplets can be performed using an apparatus enabling strong stirring, such as an in-line type emulsion dispersing machine (available from Pacific Machinery & Engineering Co., Ltd., trade name: Milder), a high-speed emulsion dispersing machine (available from PRIMIX Corporation, trade name: T. K. Homomixer type MARK II).

Examples of the polymerization initiator include persulfuric acid salts such as potassiun persulfate and ammonium persulfate; azo compounds such as 4, 4-azobis (4-cyanovaleric acid) , 2,2-azobis (2-methyl-N-(2-hydroxyethyl)propionamide), 2,2′-azobis (2-amidinopropane) dihydrochloride, 2,2′ -azobis (2,4-dimethylvaleronitrile) , and 2,2′-azobisisobityronitrile; organic peroxides such as di-t-butyl peroxide, benzoyl peroxide, t-butyl peroxy-2-ethylhexanoate, t-hexyl peroxy-2-ethylbutanoate, diisopropyl peroxydicarbonate, di-t-butyl peroxyoxyisophthalate and t-butyl peroxyisbutyrate; and the like. These can be used alone or in combination. Among these, preferred is use of an organic peroxide because it can reduce residual polymerizable monomer: and ensure high print durability. Among these organic peroxides, peroxy esters are preferred, and non aromatic peroxy esters, i.e., peroxy esters without having an aromatic ring are more preferred because these initiators have high efficiency and can reduce residual polymerizable monomer.

The polymerization initiator may be added after the polymerizable monomer composition is dispersed in the aqueous medium as described above and before droplets are formed, or may be added to the polymerizable monomer composition before the polymerizable monomer composition is dispersed in the aqueous medium (medium mainly containing water).

The polymerization initiator used for polymerization of the polymerizable monomer composition is added in an amount of preferably 0.1 to 20 parts by mass, more preferably 0.3 to 15 parts by mass, still more preferably 3 to 5 parts by mass, particularly preferably 3 to 4 parts by mass relative to 100 parts by mass of the binder resin (100 parts by mass of the polymerizable monomer to prepare the binder resin).

In the present invention, preferably, the aqueous medium contains a dispersion stabilizer. Examples of the dispersion stabilizer include inorganic compounds such as sulfates such as barium sulfate and calcium sulfate; carbonates such as barium carbonate, calcium carbonate, and magnesian carbonate; phosphates such as calcium phosphate; metal oxides such as aluminum oxide and titanium oxide; metal hydroxides such as aluminum hydroxide, magnesium hydroxide, and ferric hydroxide; and organic compounds such as water-soluble polymers such as poly(vinyl alcohol), methyl cellulose, and gelatin; anionic surfactants; nonionic surfactants; and amphoteric surfactants. These dispersion stabilizers can be used alone or in combination. The dispersion stabilizer is added in an amount of preferably 0.1 to 20 parts by mass, more preferably 0.2 to 10 parts by mass relative to 100 parts by mass of the binder resin (100 parts by mass of the polymerizable monomer to prepare the binder resin).

Among these dispersion stabilizers, preferred are inorganic compounds, and particularly preferred are colloids of poorly water-soluble metal hydroxides. Use of an inorganic compound, particularly a colloid of a poorly water-soluble metal hydroxide results in colored resin particles having a narrow particle size distribution, and can reduce the amount of residual dispersion stabilizer after washing, thus enabling reproduction of images by the resulting toner without reducing the environmental stability.

(A-3) Polymerization Step

The desired suspension (aqueous dispersive medium containing droplets of the polymerizable monomer composition) prepared in the step (A-2) for preparing the suspension (droplet forming step) is heated to initiate polymerization. Thereby, an aqueous dispersion of colored resin particles containing the binder resin, the colorant, the charge control agent, and the release agent, and optionally the additive having a polydiene structure is prepared.

The polymerization temperature in the present invention is preferably 50° C. or more, more preferably 60 to 95° C. The polymerization time in the present invention is preferably 1 to 20 hours, more preferably 2 to 15 hours.

To keep droplets of the polymerizable monomer composition stably dispersed during polymerization, the polymerization may be allowed to progress while the dispersion treatment by stirring is continued in the polymerization step from the suspension step (A-2) for preparing a suspension (droplet forming step).

In the present invention, the external additive may be added to the thus-prepared colored resin particles as they are, and the product may be used as a toner. Alternatively, so-called core-shell type (or also referred to as “capsule type”) colored resin particles may be prepared, the colored resin particles comprising a core layer of the colored resin particles prepared through the polymerization step and a shell layer which is different from the core layer and disposed on the outer side thereof. In the core-shell type colored resin particles, a core layer made of a substance having a low softening point is coated with a substance having a softening point higher than that. Thereby, the storage stability and low-temperature fixing properties of the resulting toner can be further enhanced.

The core-shell type colored resin particles can be produced by any known traditional method without limitation. From the viewpoint of production efficiency, preferred is in situ polymerization or phase separation.

A method of producing the core-shell type colored resin particles by in situ polymerization will now be described.

In in situ polymerization, a polymerizable monomer for forming a shell layer (polymerizable monomer for a shell) and a polymerization initiator for a shell are added to an aqueous dispersive medium having colored resin particles dispersed therein, followed by polymerization. Thereby, the core type colored resin particles can be prepared.

The polymerizable monomer for the shell to be used can be the same polymerizable monomer as described above. Among these, it is preferred that monomers (such as styrene and methyl methacrylate) which can provide a polymer having a Tg more than 80° C. be used alone or in combination.

Examles of the polymerization initiator for the shell used in polymerization of the polymerizable monomer for the shell include polymarization initiators such as metal salts of persulfuric acids such as potassium persulfate and ammonium persulfate; water-soluble azo compounds such as 2,2′-azobis (2-methyl-N-(2-hydroxyethyl)propionamide) and 2,2′-azobis-(2-methyl-N-(1,1-bis(hydroxymethyl)2-hydroxyethyl)propionamide); and the like. The polymerization initiator for the shell is used in an amount of preferably 0.1 to 30 parts by mass, more preferably 1 to 20 parts by mass relative to 100 parts by mass of the polymerizable monomer for the shell.

The polymerization temperature of the shell layer is preferably 50° C. or more, more preferably 60 to 95° C. The polymerization time of the shell layer is preferably 1 to 20 hours, more preferably 2 to 15 hours.

(A-4) Washing, Filtration, Dehydration, and Drying Steps

After the end of polymerization, it is preferred that the aqueous dispersion of the colored resin particles prepared through the polymerization step (A-3) be repeatedly, as needed, subjected to a series of operations of washing filtration, dehydration, and drying according to a normal method.

First, to remove the residual dispersion stabilizer in the aqueous dispersion of the colored resin particles, preferably, an acid or alkali is added to the aqueous dispersion of the colored resin particles to wash the aqueous dispersion. If the dispersion stabilizer used is an inorganic compound soluble to acids, washing is preferably performed by adding an acid to the aqueous dispersion of the colored resin particles. If the dispersion stabilizer used is an inorganic compound soluble to alkalis, washing is preferably performed by adding an alkali to the aqueous dispersion of the colored resin particles.

Moreover, if the inorganic compound soluble to acids is used as the dispersion stabilizer, it is preferred that the acid be added to the aqueous dispersion of the colored resin particles to adjust the pH to preferably 6.5 or less, more preferably 6 or less. The acid to be added can be inorganic acids such as sulfuric acid, hydrochloric acid, and nitric acid, and organic acids such as formic acid and acetic acid. Particularly suitable is sulfuric acid because of its great efficiency in removing the dispersion stabilizer and a small load on production facilities.

Dehydration and filtration can be performed by a variety of known methods, which are not particularly limited. Examples thereof include centrifugal filtration, vacuum filtration, pressurized filtration, and the like. The drying method is also not particularly limited, and a variety of methods can be used.

(B) Process

If the pulverization process is used, the colored resin particles are produced by the following process.

First, the binder resin, the colorant, the charge control agent, the release agent, the additive having a polydiene structure, and other additives optionally added are mixed with a mixer, such as a ball mill, a V-type mixer, a Henschel mixer (trade name), a high speed dissolver, an internal mixer, or a Forberg mixer. In the next step, the resulting mixture is kneaded under heating using a pressure kneader, a twin-screw extrusion kneader, a roller, or the like. The kneaded product is crushed using a mill such as a hammer mill, a cutter mill, or a roller mill. Furthermore, the product is pulverized using a mill such as a jet mill or a high speed rotary mill, and is classified into a desired particle size with a classifier such as an air classifier or an air stream classifier. Thus, colored resin particles can be prepared by the pulverization process.

The binder resin, the colorant, the charge control agent, the release agent, and the additive having a polydiene structure, and other additives optionally added, which are used in the pulverization process, can be the same as those listed in (A) Suspension polymerization process above. Moreover, the colored resin particles prepared by the pulverization process can be formed into the core shell type colored resin particles by a method such as in situ polymerization as in the colored resin particles prepared by (A) Suspension polymerization process above.

The binder resin to be used may be any of the binder resins listed above and resins widely used for toners in the related art. Examples of the binder resins used in the pulverization process specifically include polystyrene, styrene-butyl acrylate copolymers, polyester resins, epoxy resins, and the like.

(Colored Resin Particles)

The colored resin particles are prepared through (A) Suspension polymerization process or (B) Pulverization process above.

The colored resin particles forinq a toner will now be described. The colored resin particles described below comprise both colored resin particles of a core-shell type and those of a non-core-shell type.

The colored resin particles used in the present invention have a storage modulus G′ (60) at 60° C., a storage modulus G′ (100) at 100° C., and a storage modulus G′ (150) at 150° C. controlled to fall within specific ranges, these storage moduli being determined by dynamic viscoelastic analysis. Specifically, the colored resin particles used in the present invention have a storage modulus G′ (60) at 60° C. controlled within the range of 1.0×10⁸ to 5.0×10⁸ Pa, a storage modulus G′ (100) at 100° C. controlled within the range of 8.0×10⁴ to 2.3×10⁵ Pa, and a storage modulus G′ (150) at 150° C. controlled within the range of 1.4×10⁴ to 3.0×10⁴ Pa, these storage moduli being determined by dynamic viscoelastic analysis. According to the present invention, when the storage moduli G's at 60° C., 100° C., and 150° C. of the colored resin particles are controlled within these ranges above, the storage stability of the resulting toner, the low-temperature fixing properties thereof, and the filming resistance thereof to the fixing film can be further enhanced.

The colored resin particles have a storage modulus G′ (60) at 60° C. in the range of 1.0×10⁸ to 5.0×10⁸ Pa, preferably 1.1×10⁸ to 2.9×10⁸ Pa, more preferably 1.3×10⁸ to 2.8×10⁸ Pa, the storage modulus C′ (60) being determined by dynamic viscoelastic analysis. An extremely low storage modulus G′ (60) at 60° C. results in reduced storage stability while an extremely high storage modulus G′ (60) results in reduced low-temperature fixing properties.

The colored resin particles have a storage modulus G′ (100) at 100° C. in the range of 8.0×10⁴ to 2.3×10⁵ Pa, preferably 1.1×10⁵ to 2.2×10⁵ Pa, more preferably 1.2×10^{s} to 2.2×10⁵ Pa, the storage modulus G′ (100) being determined by dynamic viscoelastic analysis. An extremely low storage modulus G′ (100) at 100° C. results in reduced storage stability while an extremely high storage modulus C′ (100) results in reduced low-temperature fixing properties.

The colored resin particles have a storage G′ (150) at 150° C. in the range of 1.4×10⁴ to 3.0×10⁴ Pa, preferably 1.4×10⁴ to 2.5×10⁴ Pa, more preferably 1.4×10⁴ to 2.2×10⁴ Pa, the storage modulus G′ (150) being determined by dynamic viscoelastic analysis. An extremely low storage modulus G′ (150) at 150° C. results in poor filming resistance to the fixing film while an extremely high storage modulus G′ (150) results in reduced low-temperature fixing properties.

Although the colored resin particles can have any ratio G′ (60)/G′ (100) of the storage modulus G′ (60) at 60° C. to the storage modulus G′ (100) at 100° C., which storage moduli are determined by dynamic viscoelastic analysis, to further enhance the storage stability of the resulting toner, the low-temperature fixing properties thereof, and the filming resistance thereof to the fixing film, the ratio is controlled within the range of preferably 5.0×10² to 1.5×10³, more preferably 6.0×10² to 1.4×10³, still more preferably 7.5×10² to 1.3×10³.

Although the colored resin particles can have any ratio G′ (100) /G′ (150) of the storage modulus G′ (100) at 100° C. to the storage modulus G′ (150) at 150° C., which storage moduli are determined by dynamic viscoelastic analysis, to further enhance the storage stability of the resulting toner, the low-temperature fixing properties thereof, and the filming resistance thereof to the fixing film, the ratio is controlled within the range of preferably 3.0 to 15.0, more preferably 4.0 to 13.5, still more preferably 5.0 to 11.0.

The storage modulus G′ (60) at 60° C., the storage modulus C′ (100) at 100° C., and the storage modulus G′ (150) at 150° C. of the colored resin particles can be measured by any method without limitation, and can be determined as follows: The colored resin particles are sandwiched between a pair of plates of 8, mmϕ under a load of 20 g (colored resin particles are uniformly placed in an area of 8 mmϕ and sandwiched by a pair of plates under a load of 20 g) to prepare a sample for measurement; and then, the sample is subjected to dynamic viscoelastic analysis by a dynamic rheometer using a rotary flat plate type rheometer in the range of 45 to 150° C. at a measurement frequency of 24 Hz and a heating rate of 5° C./min.

In the present invention, the storage modulus G′ (60) at 60° C., the storage modulus G′ (100) at 100° C., and the storage modulus G′ (150) at 150° C. of the colored resin particles can be controlled within the ranges above by any method. Examples thereof include a method of controlling the proportion of monomer units derived from the monovinyl monomer (e.g., proportion of styrene-based monomer units) in the binder resin used in the present invention within the ranges above, a method of controlling the amount of the cross-linkable polymerizable monomer (cross-linking agent) to be used in preparation of the binder resin used in the present invention within the ranges above, a method of controlling the amount of release agent to be used within the ranges above, a method of controlling the amount of the polymerization initiator and that of the molecular weight modifier to be used during polymerization of the polymerizable monomer composition within the ranges above, a method of adding the additive having a polydiene structure to the colored resin particles and controlling the amount thereof added within the ranges above, and the like. These methods can be appropriately combined.

To further improve the storage stability, the low-temperature fixing properties, and the filming resistance to the fixing film, the melt temperature (T1/2) of the colored resin particles determined by the 1/2 method is preferably 150 to 220° C., more preferably 1.52 to 210° C., still more preferably 155 to 200° C. The melt temperature (T1/2) of the colored resin particles determined by the 1/2 method can be measured using a flowtester at a measurement starting temperature of 40° C., a heating rate of 3 ° C./min, a preheating time of 5 minutes, a cylinder pressure of 10 kgf/cm², a die diameter of 0.5 mm, and a the length of 1.0 mm.

From the viewpoint of image reproductivity, the colored resin particles have a volume average particle size Dv of preferably 3 to 15 μm, more preferably 4 to 12 μm, still more preferably 5 to 8 μm. When the colored resin particles have a volume average particle size Dv below the range above, the fluidity of the toner my be reduced, and degradation of image quality caused by fogging or the like is more likely to occur in some cases. In contrast, when the colored resin particles have a volume average particle size Dv beyond the range above, resolutions of formed images may be reduced in some cases.

From the viewpoint of image reproductivity, the particle size distribution (Dv/Dn), which is the ratio of the volume average particle size (Dv) of the colored resin particles to the number average particle diameter (Dn) thereof, is preferably 1.00 to 1.30, more preferably 1.00 to 1.20. When the colored resin particles have a particle size distribution (Dv/Dn) beyond the range above, the fluidity of the toner may be reduced, and degradation of image quality caused by fogging or the like is more likely to occur in some cases. The volume average particle size Dv and the number average particle diameter Dn of the colored resin particles can be seasoned with a particle size analyzer (available from Beckman Coulter, Inc., trade name: Multisizer) or the like.

From the viewpoint of image reproductivity, the colored resin particles have an average circularity of preferably 0.960 to 1.000, more preferably 0.970 to 1.000, still more preferably 0.980 to 1.000.

The above-mentioned colored resin particles may be used as a toner as they are or as a mixture with carrier particles (ferrite, iron powder, and the like). To adjust the charging properties, fluidity, storage properties, and the like of the toner, an external additive my be added to and mixed with the colored resin particles using a high speed stirrer (such as a FM mixer (trade name, available from NIPPON COKE & ENGINEERING CO., LTD.)) to prepare a one-component toner. Furthermore, the colored resin particles, an external additive, and further carrier particles may be mixed to prepare a two-component toner.

The stirrer for executing external addition can be any stirrer as long as it enables the external additive to adhere to the surfaces of the colored resin particles. For example, external addition can be executed with a stirrer enabling mixing under stirring, such as an FM mixer (trade name, available from NIPPON COKE & ENGINEEPING CO., LTD.), a SUPERMIXER (trade name, available from Kawata MFG, Co., Ltd.), a Q mixer (trade name, available from NIPPON COKE & ENGINEERING CO., LTD.), a MECHANO FUSION system (trade name, available from Hosokawa Micron Corporation), or a Mechno Mill (trade name, available from Okada Seiko Co., Ltd.).

Examples of the external additive include include inorganic fine particles of silica, titanium oxide, aluminum oxide, zinc oxide, tin oxide, calcium carbonate, calcium phosphate, cerium oxide, and the like; organic fine particles of polymethyl, methacrylate resins, silicone resins, melamine resins, and the like. Among these, preferred are inorganic fine particles, more preferred are silica and titanium oxide, and particularly preferred is silica. It is preferred that a combination of two or more fine particles be used as the external additive. These external additives may be used alone, and a combined use thereof is preferred.

Desirably, the amount of the external additive to be used is preferably 0.3 to 6 parts by mass, more preferably 1.2 to 3 parts by mass relative to 100 parts by mass of the colored resin particles.

The toner according to the present invention comprises colored resin particles containing a binder resin, a colorant, a charge control agent, and a release agent and having a storage modulus G′ (60) at 60° C. of 1.0×10⁸ to 5.0×10⁸ Pa, a storage modulus G′ (100) at 100° C. of 8.0×10⁴ to 2.3×10⁸ Pa, and a storage modulus G′ (150) at 150° C. of 1.4×10⁴ to 3.0×10⁴ Pa, these storage moduli being determined by dynamic viscoelastic analysis. The toner according to the present invention has hide storage stability, excellent low-temperature fixing properties, and high filming resistance to the fixing film, and thus can sufficiently meet recent demands for a reduction in energy consumption and an increase in printing speed.

### EXAMPLES

Hereinafter, the present invention will be more specifically described by way of Examples and Comparative Examples, but the present invention will not be limited only to these Examples. To be noted, “parts” and “%” are mass-based unless otherwise specified.

The test methods performed in Examples and Comparative Examples are as described below.

(1) Weight Average Molecular Weight of Conjugated Diene-Aromatic Vinyl Thermoplastic Elastomer

The weigh average molecular weight of the conjugated diene-aromatic vinyl thermoplastic elastomer was determined as a molecular weight against polystyrene standards by high performance liquid chromatography using tetrahydrofuran at a flow rate of 0.35 ml/min as a carrier. The apparatus used was HLC8220 available from Tosoh Corporation, and three connected Shodex (registered trademark) KF-404HQ columns available from Showa Denko K.K. (column temcerature of 40° C.) were used. A differential refractometer and an ultraviolet detector were used as detectors. The molecular weight was calibrated against 12 points of standard polystyrenes (from 500 to 3000000) available from Polymer Laboratories Ltd.

(2) Contents of Block Copolymers in Conjugated Diene-Aromatic Vinyl Thermoplastic Elastomer

The contents of block copolymers were determined from the ratios of the areas of the peaks corresponding to the block copolymers in the chart obtained by high performance liquid chromatography above.

(3) Weight Average Molecular Weight of Styrene Polymer Block of Each of Block Copolymers Forming Conjugated Diene-Aromatic Vinyl Thermoplastic Elastomer

According to the method described in Rubber Chem. Technol., 45, 1295 (1972), the isoprene polymer block of each block copolymer was decomposed by reacting the block copolymer with ozone, followed by reduction with lithium aluminum hydride. Specifically, the following procedure was performed. Namely, 300 mg of a sample was dissolved in a reaction vessel containing 100 ml of dichloromethane treated with a molecular sieve . This reaction vessel was placed into a cooling tank, and was cooled to −25° C. Thereafter, while oxygen was flowing into the reaction vessel at a flow rate of 170 ml/min, ozone generated by an ozone generator was introduced. After 30 minutes had passed from the start of the reaction, it was confirmed that the reaction had been completed, by introducing the gas flowing out of the reaction vessel into a potassium iodide aqueous solution. In the next step, 50 ml of diethyl ether and 470 mg of lithium aluminum hydride were placed into another reaction vessel purged with nitrogen. While the reaction vessel was being cooled with iced water, the solution reacted with ozone was slowly added dropwise to this reaction vessel. Thereafter, the reaction vessel was placed into a water bath, acid was gradually heated, and the solution was refluxed at 40° C. for 30 minutes. Subsequently, while the solution was being stirred, diluted hydrochloric acid was added dropwise to the reaction vessel in small portions. The addition was continued until generation of hydrogen was hardly observed. After this reaction, a solid product formed in the solution was separated through filtration, and was extracted with 100 ml of diethyl ether for 10 minutes. The extract and the filtrate obtained from the filtration were combined, and the solvent was distilled off to yield a solid sample. The resulting sample as above was measured for the weight average molecular weight according to the above-described method of measuring the weight average molecular weight, and the measured value was defined as the weight average molecular weight of the styrene polymer block.

(4) Weight Average Molecular Weight of Isoprene Polymer Block in Each of Block Copolymers Forming Conjugated Diene-Aromatic Vinyl Thermoplastic Elastomer

For each of the block copolymers, the weight average molecular weight of the styrene polymer block was subtracted from the weight average molecular weight of the corresponding block copolymer. Based on the calculated value, the weight average molecular weight of the isoprene polymer block was determined.

(5) Content of Styrene Units in Block Copolymers Forming Conjugated Diene-Aromatic Vinyl Thermoplastic Elastomer

The content of styrene units was determined based on the ratio of intensities detected by the differential refractometer and the ultraviolet detector in the measurement by high performance liquid chromatography. To be noted, copolymers having different contents of styrene units were preliminarily prepared, and were used to create a calibration curve.

(6) Vinyl Band Content in Isoprene Polymer Block in Each of Block Copolymers Forming Conjugated Diene-Aromatic Vinyl Thermoplastic Elastomer

The vinyl bond content was determined based on proton NMR measurement.

(7) Content of Styrene Units in Conjugated Diene-Aromatic Vinyl Thermoplastic Elastomer

The content of styrene units was determined based on proton NMR measurement.

(8) Malt Index of Conjugated Diene-Aromatic Vinyl Thermoplastic Elastomer

The melt index was measured according to ASTM D1238 (G condition, 200° C., load: 5 kg).

(9) Melt Temperature (T1/2) of Colored Resin Particles

The melt temperature (T1/2) of the colored resin particles by the 1/2 method was calculated from the melt viscosity obtained using a flowtester. Specifically, the melt viscosity was measured using a flowtester (available from SHIMADZU Corporation, trade name: CFT-500C) at a predetermined starting temperature and a predetermined heating rate for a predetermined preheating time with a predetermined shear stress. Thereafter, the melt temperature (T1/2) by the 1/2 method was determined from the obtained melt viscosity.

measurement starting temperature: 40° C., heating rate: 3° C./min, preheating time: 5 minutes, cylinder pressure: 10 kgf/cm², die diameter: 0.5 cm, die length: 1.0 mm

(10) Storage Modulus G′ (60) at 60° C., Storage Modulus G′ (100) at 100° C., Storage Modulus G′ (150) at 150° C. of Colored Resin Particles

The colored resin particles were sandwiched between a pair of plates (parallel plates or cross-hatched plates were used) of 8 mmϕ under a load of 20 g (the colored resin particles were uniformly placed on an area of 8 mmϕ and sandwiched between a pair of plates under a load of 20 g) to prepare a sample for measurement. The sample was subjected to dynamic viscoelastic analysis by a dynamic rheometer using a rotary plat plate rheometer (product name “ARES-G2”, available from TA Instruments-Waters Corporation LLC) under a load of 20 g in the range of 45 to 150° C. at a measurement frequency of 24 Hz and a heating rate of 5° C./min.

(11) Evaluation of Storage Properties of Toner

10 g of the toner was placed into a 100-mL polyethylene vessel, and the vessel was sealed. Thereafter, the vessel was immersed into a thermosat water bath set at a predetermined temperature, and was extracted therefrom after 8 hours had passed. The toner was transferred from the extracted vessel onto a 42-mesh sieve without being vibrated as much as possible, and the sieve was set on a powder analyzer (available from Hosokawa Micron Corporation, trade name: Powder Tester PT-R). The amplitude of the sieve was set to 1.0 mm, and the sieve was vibrated for 30 seconds. Thereafter, the mass of the toner left on the sieve was measured, and was defined as the mass of toner aggregates. The highest temperature (°C.) at which the mass of the toner aggregates was 0.5 g or less was defined as a storage temperature, which is an index for storage properties.

(12) Lowest Fixing Temperature of Toner

A fixing test was performed using a commercially available printer or a non-magnetic one-component developing method (printing speed: 20 ppm) modified to vary the temperature of the fixing roll. In the fixing test, a solid black (print density: 100%) image was printed, and the fixing rate of the toner was measured every time when the temperature of the fixing roll in the modified printer was varied by 5° C. Thus, the relation between the temperature and the fixing rate was determined. The fixing rate was determined by peeling of a tape from the solid black (print density: 100%) print region and calculation from the ratio of the image density after peeling to that before peeling. In other words, the image density before peeling is defined as ID (before), the image density after pooling is defined as ID (after), and the fixing rate can be calculated from the following calculation expression:

fixing rate(%)=(ID(after)/ID(before))×100

Here, the peeling operation indicates a series of operations of applying an adhesive tape (available from Sumitomo 3M Limited, trade name: Scotch mending tape 810-3-18) to a portion of a test paper short to be measured, pressing and bonding the adhesive tape to the portion under a certain pressure, and then peeling the adhesive tape at a fixed speed in a direction along the paper shoot. The image density was measured with a reflective image densitometer (available from Gretag Macbeth GmbH, trade

In the fixing test, the lowest temperature of the fixing roll at which the fixing rate exceeded 80% was defined as the lowest fixing temperature of the toner.

(13) Test on Filming of Toners to Fixing Film

Print paper sheets were set in a commercially available film-fixing printer of a non-magnetic one-component developing method (resolution: (600 dpi, printing rate: 28 sheets/min), and each toner was charged into the developing unit. The printer was left to stand in a low temperature and low humidity (L/L) environment at a temperature of 10° C. and a humidity of 20% RH for 24 hours, and printing up to 10,000 sheets was continuously performed at a print density of 4% in the same environment. A solid print (print density: 100%) was output every 500 sheets, and was visually observed about the presence/absence of printing defects such as black spots (places having abnormal application of the toner) and white spots (places having peel-off of the toner) to evaluate filming resistance of the toner to the fixing film according to the following criteria:

A: None of printing defects, i.e., black spots and white spots was observed in the continuous printing of 10,000 sheets.

F: At least one of printing defects, i.e., black spots and white spots was observed in the continuous printing of 10,000 sheets.

### Production Example 1

23.2 kg of cyclohexane, 1.5 mmol of N,N,N′,N′-tetramethylethylenediamine (hereinafter, referred to as TMEDA), and 1.70 kg of styrene were added to a pressure-resistant reactor, and were stirred at 40° C. Under stirring, 99.1 mmol of n-butyllithium was added, and styrene was polymerized for one hour while the system was being heated to 50° C. The polymerization conversion ratio of styrene was 100% by weight. Subsequently, while the temperature was maintained at 50 to 60° C. by control, 6.03 kg of isoprene was continuously added to the reactor over one hour. After the addition of isoprene was completed, polymerization was performed for another one hour to form a styrene-isoprene diblock copolymer B (copolymer B represented by Ar-D). The polymerization conversion ratio of isoprene was 100%. In the next step, 15.0 mmol of dimethyldichlorosilane as a coupling agent was added to cause a coupling reaction, which lasted for two hours. Thereby, a styrene-isoprene-styrene triblock copolymer (copolymer A represented by Ar-D-Ar) was formed. Thereafter, 190 mmol of methanol as a polymerization terminator was added, and was sufficiently mixed to terminate the reaction. Thereby, a reaction solution containing a block copolymer composition (α1) was prepared. An aliquot of the resulting reaction solution was removed, and analyzed for the weight average molecular weights of the block copolymers and the entire block copolymer composition, the proportions thereof, and the vinyl bond content. The results are shown in Table 1. Subsequently, 0.3 parts of 2,6-di-tert-butyl-p-cresol as an antioxidant was added to and mixed with 100 parts of the resulting reaction solution (containing 30 parts of the polymer components), and a small amount of the mixed solution was added dropwise to hot water heated to 85 to 95° C. The solvent was volatilized to obtain a precipitate. The precipitate was crushed, and was dried at 85° C. with hot air to recover a block copolymer composition (α1). The block copolymer composition (α1) was measured for the melt index. The result is shewn in Table 1. The block copolymer composition (α1) was measured for the solubility in styrene at a temperature of 40° C. The solubility was 20 g/100 g.

### Production Example 2

### Production Example of Acrylic Resin

200 Parts of toluene was placed into a reaction vessel, and the inside of the reaction vessel was sufficiently purged with nitrogen while toluene was being stirred. Thereafter, the system was heated to 90° C., and a mixed solution of 95 parts of methyl methacrylate, 4.6 parts of n-butyl acrylate, 0.4 parts of acrylic acid, and 2.8 parts of t-butyl peroxy-2-ethylhexanoate (available from NOF Corporation, trade name: Perbutyl O) was added dropwise to the reaction vessel over 2 hours. Furthermore, the system was kept for 10 hours under refluxing of toluene to complete polymerization, and the solvent was distilled away under reduced pressure. Thus, an acrylic resin (Tg: 70° C., acid value: 2.5, weight reduced pressure. molecular weight (Mw): 11000) was yielded.

TABLE 1

| | Production |
|---|---|
| | Example 1 |
| Type | (a1) |
| Styrene-isoprene-styrene triblock copolymer A | |
| Weight average molecular weight of | 218,000 |
| styrene-isoprene-styrene triblock copolymer A | |
| Weight average molecular weight of styrene block | 17,000 |
| Content [%] of styrene units in styrene-isoprene- | 22 |
| styrene triblock copolymer A | |
| Vinyl bond content [mol %] in isoprene block | 7 |
| Weight average molecular weight of | 184,000 |
| isoprene block | |
| Styene-isoprene diblock copolymer B | |
| Weight average molecular weight of styrene- | 109,000 |
| isoprene diblock copolymer B | |
| Weight average molecular weight of styrene block | 17,000 |
| Content [%] of styrene units in styrene-isoprene | 22 |
| diblock copolymer B | |
| Vinyl bond content [mol %] in isoprene block | 7 |
| Weight average molecular weight of isoprene | 92,000 |
| block | |
| Entire block copolymer composition | |
| Weight average molecular weight of entire block | 142,000 |
| copolymer composition | |
| Content [%] of styrene units | 22 |
| Vinyl bond content [mol %] in isoprene block | 7 |
| Proportion [%] of styrene-isoprene-styrene | 30 |
| triblock copolymer A | |
| Proportion [%] of styrene-isoprene diblock | 70 |
| copolymer B | |
| Proportion of 3- and 4-branched styrene-isoprene | — |
| block copolymers C and D | |
| Melt index [g/10 min] G condition | 10 |

### Example 1

74 Parts of styrene and 26 parts of n-butyl acrylate as monovinyl monomers, 9 parts of carbon black (available from Mitsubishi Chemical Corporation, trade name: #25B) as a colorant, 0.41 parts of divinylbenzene as a cross-linkable polymerizable monomer (cross-linking agent), 1.0 part of t-dodecylmercaptan as a molecular weight modifier, and 1 part of the acrylic resin prepared in Production Example 2 were wet ground with a medium-type wet grinder. Thereafter, 1 part of a charge control resin (styrene/acrylic resin containing a quaternary ammonium salt as a functional group, proportion of a copolymerized monomer containing a functional group of a quaternary ammoniun salt: 2%) as a charge control agent, 20 parts of behenyl stearate (number average molecular weight (Mn):592) as a release agent, and 5 parts of the block copolymer composition (α1) prepared in Production Example 1 as the additive having a polydiene structure were added and mixed to prepare a polymerizable monomer composition.

On the other hand, in a stirring tank, under stirring at room temperature, an aqueous solution of 4.1 parts of sodium hydroxide (alkali metal hydroxide) dissolved in 50 parts of deionized water was gradually added to an aqueous solution of 7.4 parts of magnesium chloride (water-soluble polyvalent metal salt) dissolved in 250 parts of deionized water. Thereby, a magnesium hydroxide colloid (poorly water-soluble metal hydroxide colloid) dispersion was prepared.

Separately, 3 parts of methyl methacrylate as a polymerizable monomer for the shell and 65 parts of deionized water were finely dispersed with an ultrasonic emulsifying machine to prepare an aqueous dispersion of the polymerizable monomer for the shell.

The polymerizable monomer composition was added to the magnesium hydroxide colloid dispersion prepared above, followed by stirring until droplets were stabilized. Then, 3.3 parts of t-butyl peroxyisobutyrate (available from NOF CORPORATION, trade name: Perbutyl IB) as a polymerization initiator was added thereto, and droplets of the polymerizable monomer composition were formed by dispersing the polymerizable monomer composition while being circulated with high shear stirring at a number of rotations of 15,000 rpm using an in-line type emulsion dispersing machine (available from Pacific Machinery & Engineering Co., Ltd., trade name: Milder).

In the next step, 1 part of sodium tetraborate decahydrate was added to the aqueous dispersion of droplets of the polymerizable monomer composition. The aqueous dispersion was placed into a reactor with a stirring blade, and the system was heated to 85° C. to cause polymerization. After the polymerization conversion ratio reached substantially 100%, the system was heated to 95° C., and the polymerization was further continued for 3 hours. The system was then cooled with water to terminate the reaction. Thus, an aqueous dispersion of colored resin particles having a core-shell structure was prepared.

The aqueous dispersion of the colored resin particles was washed with dilute sulfuric acid (25° C., for 10 minutes) to adjust the pH to 4.5 or less. In the next step, water was separated through filtration, and 200 parts of fresh deionized water was added to prepare a slurry again. The slurry was repeatedly subjected to a water washing treatment. (washing, filtration, and dehydration) at room temperature (25° C.). Then, the resulting solids were separated through filtration, and were dried in vacuum to prepare dry colored resin particles. The resulting colored resin particles were measured for the melt temperature (T1/2) by the 1/2 method, the storage modulus G′ (60) at 60° C., the storage modulus G′ (100) at 100° C., and the storage modulus G′ (150) at 150° C. according to the methods described above. The results are shown in Table 2.

An external addition treatment was performed in which as external additives, 0.5 parts of silica fine particles hydrophobized with cyclic silazane and having a number average primary particle size of 7 nm and 1 part of silica fine particles hydrophobized with amino-modified silicone oil and having a number average primary particle size of 35 nm were added to 100 parts of the colored resin particles prepared above, and these were mixed with stirring using a high speed stirrer (available from NIPPON COKE & ENGINEERING CO., LTD., trade name: FM mixer). Thus, a toner for development of electrostatic images was prepared. The resulting toner for development of electrostatic images was measured and evaluated for storage properties, the lowest fixing temperature, and filming to the fixing film. The results are shown in Table 2.

### Example 2

Colored resin particles were prepared in the same manner as in Example 1 except that the amount of divinylbenzene used was changed to 0.52 parts, and a toner for development of electrostatic images was prepared in the same manner as in Example 1. These were evaluated as described above. The results are shewn in Table 2.

### Example 3

Colored resin particles were prepared in the same manner as in Example 1 except that the amount of divinylbenzene used was changed to 0.63 parts, and a toner for development of electrostatic images was prepared in the same manner as in Example 1. These were evaluated as described above. The results are shown in Table 2.

### Example 4

Colored resin particles were prepared in the same manner as in Example 1 except that the amount of divinylbenzene used was changed to 0.68 parts, and a toner for development of electrostatic images was prepared in the same manner as in Example 1. These were evaluate as described above. The results are shown in Table 2.

### Example 5

Colored resin particles were prepared in the same manner as in Example 1 except that the amount of divinylbenzene used was changed to 0.72 parts, and a toner for development of electrostatic images was prepared in the same manner as in Example 1. These were evaluated as described above. The results are shown in Table 2.

### Example 6

Colored resin particles were prepared in the same manner as in Example 1 except that the amount of divinylbenzene used was changed to 0.77 parts, and a toner for development of electrostatic images was prepared in the same manner as in Example 1. These were evaluated as described above. The results are shewn in Table 2.

### Example 7

Colored resin particles were prepared in the same manner as in Example 1 except that the amount of styrene used was chamged to 73 parts, the amount of n-butyl acrylate used was changed to 27 parts, the amount of divinylbenzene used was changed to 0.65 parts, and the amount of the block copolymer composition (α1) used was changed to 3 parts, and a toner for development of electrostatic images was prepared in the same manner as in Example 1. These were evaluated as described above. The results are shown in Table 2.

### Example 8

Colored resin particles were prepared in the same manner as in Example 1 except that the amount of styrene used was changed to 74.5 parts, the amount of n-butyl acrylate used was changed to 25.5 parts, the amount of divinylbenzene used was changed to 0.67 parts, the amount of behenyl stearate used was changed to 25 parts, and the amount of the block copolymer composition (α1) used was changed to 7 parts, and a toner for development of electrostatic images was prepare in the same manner as in Example 1. These were evaluated as described above. The results are shown in Table 2.

### Comparative Example 1

Colored resin particles were prepared in the same manner as in Example 1 except that the amount of divinylbenzene used was changed to 0.89 parts, and a toner for development of electrostatic images was prepared in the same manner as in Example 1. These were evaluated as described above. The results are shown in Table 2.

### Comparative Example 2

Colored resin particles were prepared in the same manner as in Example 1 except that the auount of divinylbenzene used was chamged to 0.30 parts, and a toner for development of electrostatic images was prepared in the same manner as in Example 1. These were evaluated as described above. The results are shown in Table 2.

### Comparative Example 31

Colored resin particles were prepared in the sale manner as in Example 1 except that the amount of styrene used was changed to 70.5 parts, the amount of butyl acrylate used was changed to 29.5 parts, the amount of divinylbenzene used was changed to 0.51 parts, and the block copolymer composition (α1) was not used, and a toner for development of electrostatic images was prepared in the same manner as in Example 1. These were evaluated as described above. The results are shown in Table 2.

### Comparative Example 4

Colored resin particles were prepared in the same manner as in Example 1 except that the amount of styrene used was changed to 70.5 parts, the amount of n-butyl acrylate used was changed to 29.5 parts, the amount of divinylbenzene used was changed to 0.54 parts, and the block copolymer composition (α1) was not used, and a toner for development of electrostatic images was prepared in the same manner as in Example 1. These were evaluated as described above. The results are shown in Table 2.

### Comparative Example 5

Colored resin particles were prepared in the same manner as in Example 1 except that the amount of styrene used was changed to 77 parts, the amount of n-butyl acrylate used was changed to 23 parts, and the amount of divinylbenzene used was changed to 0.33 parts, and a toner for development of electrostatic images was prepared in the same manner as in Example 1. These were evaluated as described above. The results are shown in Table 2.

### Comparative Example 6

Colored resin particles were prepared in the same manner as in Example 1 except that the amount of styrene used was changed to 77 parts, the amount of n-butyl acrylate used was changed to 23 parts, and the amount of divinylbenzene used was changed to 0.6 parts, and a toner for development of electrostatic images was prepared in the same manner as in Example 1. These were evaluated as described above. The results are shown in Table 2.

### Comparative Example 7

Colored resin particles were prepared in the sane manner as in Example 1 except that the amount of styrene used was changed to 72 parts, the amount of n-butyl acrylate used was changed to 28 parts, and the amount of divinylbenzene used was changed to 0.49 parts, and a toner for development of electrostatic images was prepared in the same manner as in Example 1. These were evaluated as described above. The results are shown in Table 2.

TABLE 2

| | | | Example | | | | | | | |
|---|---|---|---|---|---|---|---|---|---|---|
| | | | 1 | 2 | 3 | 4 | 5 | 6 | 7 | 8 |
| Monovinyl | Styrene | (parts) | 74 | 74 | 74 | 74 | 74 | 74 | 73 | 74.5 |
| monomers | n-Butyl acrylate | (parts) | 2 [symbol] | 2 [symbol] | 2 [symbol] | 2 [symbol] | 2 [symbol] | 2 [symbol] | 27 | 25.5 |
| Crosslinkable | Divinylbenzene | (parts) | 0.41 | 0. [symbol] 2 | 0. [symbol] 3 | 0. [symbol] | 0.72 | 0.77 | 0.65 | 0. [symbol] 7 |
| polymerizable | | | | | | | | | | |
| monomer | | | | | | | | | | |
| Release agent | Behenyl stearate | (parts) | 20 | 20 | 20 | 20 | 20 | 20 | 20 | 2 [symbol] |
| Additive having | Block copolymer | (parts) | 5.0 | 5.0 | 5.0 | 5.0 | 5.0 | 5.0 | 3.0 | 7.0 |
| polydiene | composition (α1)*¹⁾ | | | | | | | | | |
| structure | | | | | | | | | | |

| Melt temperature (T½) of colored | (° C.) | 1 [symbol] 2 | 164 | 1 [symbol] | 1 [symbol] 1 | 1 [symbol] | 20 [symbol] | 172 | 177 |
|---|---|---|---|---|---|---|---|---|---|
| resin particles | | | | | | | | | |
| Storage modulus G′ (60) at 60° C. | (Pa) | 1.3 × 10 [symbol] | 1.7 × 10 [symbol] | 1. [symbol] × 10 [symbol] | 1.8 × 10 [symbol] | 1. [symbol] × 10 [symbol] | 1.3 × 10 [symbol] | 1.2 × 10 [symbol] | 1. [symbol] × 10 [symbol] |
| of colored resin particles | | | | | | | | | |
| Storage modulus G′ (100) at 100° C. | (Pa) | 2.2 × 10 [symbol] | 2.2 × 10 [symbol] | 1.7 × 10 [symbol] | 1. [symbol] × 10 [symbol] | 1.4 × 10 [symbol] | 1.4 × 10 [symbol] | 1.1 × 10 [symbol] | 1. [symbol] × 10 [symbol] |
| of colored resin particles | | | | | | | | | |
| Storage modulus G′ (150) at 150° C. | (Pa) | 1.5 × 10⁴ | 2.2 × 10⁴ | 2.0 × 10⁴ | 1. [symbol] × 10⁴ | 2.0 × 10⁴ | 2.1 × 10⁴ | 1. [symbol] × 10⁴ | 1.9 × 10⁴ |
| of colored resin particles | | | | | | | | | |
| G′(60)/G′(100) | | 5.9 × 10² | 7.9 × 10² | 1.1 × 10³ | 1.2 × 10⁵ | 1.2 × 10⁵ | [symbol] .3 × 10² | 1.1 × 10³ | 8.4 × 10² |
| G′(100/G′(150) | | 14.8 | 10.1 | 8.5 | 7. [symbol] | 7.2 | [symbol] . [symbol] | 7.3 | 10.2 |
| Storage temperature of toner | (° C.) | [symbol] 9 | 60 | 5 [symbol] | 5 [symbol] | 5 [symbol] | 5 [symbol] | 5 [symbol] | [symbol] 0 |
| Lowest fixing temperature of toner | (° C.) | 125 | 125 | 125 | 125 | 125 | 125 | 125 | 125 |

| | | | | | | | | |
|---|---|---|---|---|---|---|---|---|
| Filming resistance of toner to fixing film | A | A | A | A | A | A | A | A |

| | | | Comparative Example | | | | | | |
|---|---|---|---|---|---|---|---|---|---|
| | | | 1 | 2 | 3 | 4 | 5 | 6 | 7 |
| Monovinyl | Styrene | (parts) | 74 | 74 | 70.5 | 70. [symbol] | 77 | 77 | 72 |
| monomers | n-Butyl acrylate | (parts) | 2 [symbol] | 2 [symbol] | 2 [symbol] .5 | 2 [symbol] . [symbol] | 23 | 23 | 28 |
| Crosslinkable | Divinylbenzene | (parts) | 0. [symbol] | 0.3 | 0.51 | 0.54 | 0.33 | 0. [symbol] | 0.49 |
| polymerizable | | | | | | | | | |
| monomer | | | | | | | | | |
| Release agent | Behenyl stearate | (parts) | 20 | 20 | 20 | 20 | 20 | 20 | 20 |
| Additive having | Block copolymer | (parts) | 5.0 | 5.0 | — | — | 5.0 | 5.0 | 5.0 |
| polydiene | composition (α1)*¹⁾ | | | | | | | | |
| structure | | | | | | | | | |

| Melt temperature (T½) of colored | (° C.) | [symbol] 2 | 141 | 128 | 135 | 14 [symbol] | 181 | 1 [symbol] |
|---|---|---|---|---|---|---|---|---|
| resin particles | | | | | | | | |
| Storage modulus G′ (60) at 60° C. | (Pa) | 1. [symbol] × 10 [symbol] | 1.0 × 10 [symbol] | 5.8 × 10⁷ | 4.1 × 10 [symbol] | 1.8 × 10 [symbol] | 1.9 × 10 [symbol] | 7.2 × 10 [symbol] |
| of colored resin particles | | | | | | | | |
| Storage modulus G′ (100) at 100° C. | (Pa) | 2. [symbol] × 10 [symbol] | 2.0 × 10 [symbol] | 9.1 × 10⁴ | 9.4 × 10 [symbol] | 2.5 × 10 [symbol] | 2.7 × 10 [symbol] | 2.0 × 10 [symbol] |
| of colored resin particles | | | | | | | | |
| Storage modulus G′ (150) at 150° C. | (Pa) | 2.2 × 10⁴ | [symbol] . [symbol] × 10³ | 3.8 × 10³ | 4.8 × 10³ | 1.1 × 10⁴ | 1. [symbol] × 10⁴ | 2.0 × 10⁴ |
| of colored resin particles | | | | | | | | |
| G′(60)/G′(100) | | 7.5 × 10² | [symbol] .0 × 10² | [symbol] .2 × 10² | 4.3 × 10 [symbol] | 7.3 × 10² | 7.0 × 10² | 3.7 × 10² |
| G′(100/G′(150) | | 11.5 | 22.7 | 23.8 | 19.4 | 23.5 | 14.2 | [symbol] . [symbol] |
| Storage temperature of toner | (° C.) | 60 | 5 [symbol] | 57 | 57 | 5 [symbol] | [symbol] 0 | [symbol] 8 |
| Lowest fixing temperature of toner | (° C.) | 130 | 12 [symbol] | 12 [symbol] | 12 [symbol] | 130 | 135 | 125 |

| | | | | | | | |
|---|---|---|---|---|---|---|---|
| Filming resistance of toner to fixing film | A | F | F | F | F | F | A |

*¹⁾Block copolymer composition (α1) is a composition comprising a styrene-isoprene diblock copolymer and a styrene-isoprene-styrene triblock copolymer. [symbol]
indicates data missing or illegible when filed

Table 2 shows that the toners in Examples 1 to 8 exhibited high storage stability, excellent low-temperature fixing properties, and high filming resistance to the fixing film, the toners being prepared using the colored resin particles which comprise a binder resin, a colorant, a charge control agent, and a release agent and have a storage modulus G′ (60) at 60′C. of 1.0×10⁸ to 5.0×10⁸ Pa, a storage modulus G′ (100) at 100° C. of 8.0×10⁴ to 2.3×10⁵ Pa, and a storage nndolus G′ (150) at 150°C. of 1.4×10⁴ to 3.0×10⁴ Pa.

In contrast, the toners in Comparative Examples 3, 4, and 7 prepared using the colored resin particles having an extremely low storage modulus G′ (60) at 60° C. exhibited lower storage temperatures and reduced storage stability.

Moreover, the toners in Comparative Examples 1, 5, and 5 prepared using the colored resin particles having an extremely large storage modulus G′ (100) at 100 ° C. exhibited an increase in the lowest fixing temperature and reduced low-temperature fixing properties.

Furthermore, the toners in Comparative Examples 2 to 5 prepared using the colored resin particles having an extremely small storage modulus G′ (150) at 150° C. caused filming to the fixing film, and were evaluated as having reduced filming resistance to the fixing film.

In Examples 1 to 8. and Comparative Examples 1 to 7, the reaction ratio of styrene and n-butyl acrylate in preparation of the binder resin forming the colored resin particles was substantially 100%. For this reason, it can be said that the proportion of the content of styrene units and that of n-butyl acrylate units in the total monovinyl monomer units contained in the binder resin was substantially the same as the ratio of the amounts thereof charged (e.g., styrene units: 74% by mass, n-butyl acrylate units: 26% by mass in Example 1).

1. A toner for development of electrostatic images comprising colored resin particles containing a binder resin, a colorant, a charge control agent, and a release agent,
wherein the colored resin particles have a storage modulus G′ (60) at 60° C. of 1.0×10⁸ to 5.0×10 Pa, a storage modulus G′ (100) at 100° C. of 8.0×10⁴ to 2.3×10⁵ Pa, and a storage modulus G′ (150) at 150° C. of 1.4×10⁴ to 3.0×10⁴ Pa, these storage moduli being determined by dynamic viscoelastic analysis.

2. The toner for development of electrostatic images according to claim 1, wherein the colored resin particles have a melt temperature (T1/2) of 150 to 220° C., the melt temperature being determined by the 1/2 method.

3. The toner for development of electrostatic images according to claim 1, wherein the colored resin particles further contain an additive having a polydiene structure and having a solubility in styrene at a temperature of 40° C. of 3 to 40 g/100 g.

4. The toner for development of electrostatic images according to claim 3, wherein the additive having a polydiene structure is a conjugated diene-aromatic vinyl thermoplastic elastomer.

5. The toner for development of electrostatic images according to claim 4, wherein the additive having a polydiene structure is a block copolymer containing at least one aromatic vinyl polymer block and at least one conjugated diene polymer block.

6. The toner for development of electrostatic images according to claim 1, wherein the release agent is a fatty acid ester compound having a number average molecular weight (Mn) of 500 to 1500.

7. The toner for development of electrostatic images according to claim 1, wherein the colored resin particles have a ratio G′ (100)/G′ (150) of 3.0 to 15.0, the ratio G′ (100)/G′ (150) being the ratio of the storage modulus G′ (100) at 100° C. to the storage modulus G′ (150) at 150° C.
